(19) United States
(12) Patent Application Publication
(10) Pub. No.: US 2023/0312363 A1
(43) Pub. Date: Oct. 5, 2023

(54) DIELECTRIC CERAMIC COMPOSITION, METHOD OF MANUFACTURING DIELECTRIC CERAMIC COMPOSITION, AND MULTILAYER CERAMIC CAPACITOR

(71) Applicants: SAMSUNG ELECTRO-MECHANICS CO., LTD., Suwon-si (KR); University of Yamanashi, Yamanashi (JP)

(72) Inventors: Ken Yamaguchi, Yokohama-shi (JP); Toshihiro Doi, Yokohama-shi (JP); Nobuyuki Koide, Yokohama-shi (JP); Kotaro Hata, Yokohama-shi (JP); Satoshi Wada, Yamanashi (JP)

(73) Assignees: SAMSUNG ELECTRO-MECHANICS CO., LTD., Suwon-si (KR); University of Yamanashi, Yamanashi (JP)

(21) Appl. No.: 18/123,034

(22) Filed: Mar. 17, 2023

(30) Foreign Application Priority Data
Mar. 31, 2022 (JP) 2022-058290

(51) Int. Cl. C01G 45/12; H01G 4/12

(52) U.S. Cl. CPC C01G 45/1221; H01G 4/1227; H01G 4/30

(57) ABSTRACT

Provided are a dielectric ceramic composition having excellent temperature properties and low DC bias dependence in a wide temperature range from room temperature to over 200° C., a method of manufacturing a dielectric ceramic composition, and a multilayer ceramic capacitor.

### CROSS-REFERENCE TO RELATED APPLICATION(S)

This application claims benefit of priority to Japanese Patent Application No. 2022-058290 filed on Mar. 31, 2022 in the Japan Patent Office, the disclosure of which is incorporated herein by reference in its entirety.

### TECHNICAL FIELD

The present disclosure relates to a dielectric ceramic composition, a method of manufacturing a dielectric ceramic composition, and a multilayer ceramic capacitor.

### BACKGROUND

As electronic control of automobiles has been used, demands for performance and reliability of electronic components used therefor have increased. For example, electronic components used in a power module of an electric vehicle may require reliability under high-temperature conditions. In the case of a ceramic capacitor, capacitance properties (X8R properties) based on temperature change may be necessary. Recently, in electric vehicles, a power semiconductor having a high operating temperature has been developed, and demand for a multilayer ceramic capacitor having high reliability at high temperature of 200° C. or higher has been increased. Also, a dielectric ceramic composition having a small DC bias dependence has been necessary at high voltages.

Various barium titanate dielectric ceramic compositions have been known. However, a dielectric ceramic composition having excellent temperature properties even under a high temperature of 200° C. or higher and low DC bias dependence has not been known.

### SUMMARY

An embodiment of the present disclosure is to provide a dielectric ceramic composition which may have excellent temperature properties in a relatively wide temperature range of 200° C. or more and low DC bias dependence, a method of manufacturing a dielectric ceramic composition, and a multilayer ceramic capacitor.

According to an embodiment of the present disclosure, a dielectric ceramic composition includes a component including a base material represented by Ba (Ti₍₁₋₂ₓ₎RₓWₓ)O₃, wherein R is Mn and/or Mg and x satisfies 0.06≤x≤0.10.

According to a second embodiment of the present disclosure, a dielectric ceramic composition includes a component including a base material represented by Ba(Ti₍₁₋₂ₓ₎RₓWₓ)O₃, wherein R is Mn and/or Mg and x satisfies 0.06≤x≤0.10. The dielectric ceramic composition is obtained by main-firing at least the base material and additives. The base material is calcined powder particles obtained by first calcining BaCO₃, TiO₂ and oxide of R using a solid phase method, mixing with WO₃ and second calcining.

According to a third embodiment of the present disclosure, a dielectric ceramic composition includes a component including a base material represented by Ba(Ti₍₁₋₂ₓ₎RₓWₓ)O₃, wherein R is Mn and/or Mg and x satisfies 0.06≤x≤0.10. The dielectric ceramic composition is obtained by main-firing at least the base material and additives. The base material is calcined powder particles obtained by first calcining BaCO₃, TiO₂ and oxide of R by a solid phase method, mixing with BaCO₃ and second calcining.

According to a fourth embodiment of the present disclosure, a dielectric ceramic composition includes a dielectric grain including a base material represented by Ba(Ti₍₁₋₂ₓ₎RₓWₓ)O₃, wherein R is Mn and/or Mg and x satisfies 0.06≤x≤0.10. The dielectric grain does not have a core-shell structure.

According to a fifth embodiment of the present disclosure, a dielectric ceramic composition includes a dielectric grain including a base material represented by Ba(Ti₍₁₋₂ₓ₎RₓWₓ)O₃, wherein R is Mn and/or Mg and x satisfies 0.06≤x≤0.10. The dielectric grain has a structure of a homogeneous system.

According to a sixth embodiment of the present disclosure, a method of manufacturing a dielectric ceramic composition includes a first calcining process of forming first calcined powder particles by calcining BaCO₃, TiO₂ and oxide of R; a second calcining process of forming a base material of the dielectric ceramic composition by further calcining a mixture of the first calcined powder particles and WO3; a main-firing process of obtaining the dielectric ceramic composition by main-firing the base material and additives. The base material is represented as Ba(Ti₍₁₋₂ₓ₎RₓWₓ)O₃, wherein R is at least one of Mn and Mg and x satisfies 0.06≤x≤0.10.

According to a sixth embodiment of the present disclosure, a method of manufacturing a dielectric ceramic composition includes a first calcining process of forming first calcined powder particles by calcining TiO₂, oxide of R, and WO₃; a second calcining process of forming a base material of the dielectric ceramic composition by further calcining a mixture of the first calcined powder particles and BaCO₃; a main-firing process of obtaining the dielectric ceramic composition by main-firing the base material and additives. The base material is represented as Ba(Ti₍₁₋₂ₓ₎RₓWₓ)O₃, wherein R is at least one of Mn and Mg and x satisfies 0.06≤x≤0.10.

The embodiments above do not enumerate the entirety of the features of the present disclosure. Also, a sub-combination of the feature groups may also be an embodiment.

### BRIEF DESCRIPTION OF DRAWINGS

The above and other aspects, features, and advantages of the present disclosure will be more clearly understood from the following detailed description, taken in combination with the accompanying drawings, in which:

FIG. 1A is a graph indicating a result of X-ray diffraction (XRD) analysis of a dielectric ceramic composition according to embodiments A1 and A2;

FIG. 1B is a graph indicating a result of X-ray diffraction (XRD) analysis of a dielectric ceramic composition according to embodiments A3 and A4;

FIG. 1C is a graph indicating a result of X-ray diffraction (XRD) analysis of a dielectric ceramic composition according to embodiments B1 and B2;

FIG. 1D is a graph indicating a result of X-ray diffraction (XRD) analysis of a dielectric ceramic composition according to comparative examples 1 and 2;

FIG. 1E is a graph indicating a result of X-ray diffraction (XRD) analysis of a dielectric ceramic composition according to comparative examples A5 and A6;

FIG. 1F is a graph indicating a result of X-ray diffraction (XRD) analysis of a dielectric ceramic composition according to comparative examples B3 and B4;

FIG. 2A is a graph indicating a capacitance-temperature change rate based on a dielectric ceramic composition according to an embodiment and a comparative example;

FIG. 2B is a graph indicating a capacitance-temperature change rate based on a dielectric ceramic composition according to an embodiment and a comparative example;

FIG. 3A is a graph indicating a dielectric constant change versus DC bias (electric field strength) based on a dielectric ceramic composition according to an embodiment and a comparative example; and

FIG. 3B is a graph indicating a dielectric constant change versus DC bias (electric field strength) based on a dielectric ceramic composition according to an embodiment and a comparative example.

### DETAILED DESCRIPTION

Hereinafter, embodiments of the present disclosure will be described as below with reference to the accompanying drawings.

### [1] Composition of Dielectric Ceramic Composition

The composition of the dielectric ceramic composition according to the embodiment will be described.

In the embodiment, the dielectric ceramic composition may include a component derived from a base material represented by Ba(Ti₍₁₋₂ₓ₎RₓWₓ)O₃. Here, “may include a component derived from a base material” may indicate that the base material may include a component modified by post-processing such as sintering. For example, the dielectric ceramic composition may include derivative grains obtained by sintering the base material.

As an example, the base material may be a barium titanate compound having a perovskite structure. In the base material, a portion of Ti site of barium titanate is substituted with R and W. R may include Mn and/or Mg. R may include both Mn and Mg.

x may satisfy 0.05≤x≤0.12. Preferably, x may satisfy 0.06≤x≤0.10. More preferably, x may satisfy 0.07≤x≤0.09. As an example, x may be 0.06, 0.07, 0.08, 0.09 and 0.10.

Whether the dielectric ceramic composition includes a component derived from the base material represented by Ba(Ti₍₁₋₂ₓ₎RₓWₓ)O₃ may be determined by analyzing dielectric grains derived from the base material in the dielectric ceramic composition, specifically, by analyzing dielectric grains derived from the base material by scanning transmission electron microscopy/wavelength dispersive spectroscopy (STEM/WDS) analysis or STEM/Electron energy loss spectroscopy (STEM/EELS) analysis.

The dielectric ceramic composition may be a dielectric ceramic composition obtained by main-firing a base material and an additive. The base material may be calcined powder obtained by first calcining BaCO₃, TiO₂ and RO by a solid phase method, and mixing with WO₃ and further second calcining. Further, the base material may be calcined powder obtained by first calcining TiO₂, RO and WO₃ by a solid phase method, mixing with BaCO₃ and further second calcining.

The dielectric ceramic composition may include dielectric grains derived from a base material represented by Ba(Ti₍₁₋₂ₓ₎RₓWₓ)O₃. Here, R may be Mn and/or Mg. x may satisfy 0.06≤x≤0.10. The dielectric grain may not have a core-shell structure.

Having no core-shell structure may indicate that a dielectric grain may not be included in a core portion and a shell portion by portions having different compositions. For example, in the case of having a homogeneous structure described later, the dielectric grain may not have a shell structure. The presence or absence of a core-shell structure may be identified by, for example, STEM observation or Scanning Electron Microscopy (SEM) observation of dielectric grains.

Also, the dielectric grain may have a homogeneous structure. Here, the homogeneous structure may indicate that the element concentration of components included in the dielectric grains may be the same among the dielectric grains, or that non-uniformity of the concentrations of the components in the dielectric grains may be sufficiently low to be negligible.

For example, in a dielectric grain a ratio of 50% or more included in the dielectric ceramic composition, a standard deviation σ of the Ti concentration in the dielectric grain may be 5% or less, 3% or less, and more preferably, 1% or less. The Ti concentration in the dielectric grains may be identified, for example, by STEM/WDS analysis or STEM/EELS analysis of dielectric grains.

In the dielectric ceramic composition, the content of RO and WO₃ included in the base material may be 5.0 weight % or more and 11.0 weight % or less based on the entire base material.

The subcomponent used for manufacturing the dielectric ceramic composition is not limited to any particular example. The dielectric ceramic composition may include a barium compound, a manganese compound, a vanadium compound, a magnesium compound, a calcium compound, a silicon compound, and the like, as a subcomponent. As an example, the barium compound may be barium oxide (BaO), barium carbonate (BaCO₃), or barium chloride (BaCl₂). The manganese compound may be manganese oxide (MnO₂, MnO₂, and Mn₃O₄). The vanadium compound may be vanadium pentoxide (V₂O₅), or the like. The magnesium compound may be magnesium oxide (MgO) or the like. The calcium compound may be calcium carbonate (CaCO₃) or the like. The silicon compound may be silicon oxide (SiO₂) or the like.

An example of the composition range of the subcomponents will be described. For example, the barium compound (the total amount of two or more types) may be used in an amount of 0.1 mol or more and 4.0 mol or less in terms of Ba based on 100 mol of the base material. Based on 100 mol of the base material, the manganese compound (the total amount in the case of two or more types) may be used in an amount of 0.01 mol or more and 0.5 mol or less in terms of Mn. Based on 100 mol of the base material, the magnesium compound (the total amount in the case of two or more types) may be used in an amount of 0.1 mol or more and 2.0 mol or less in terms of Mg. Based on 100 mol of the base material, the vanadium compound (the total amount in the case of two or more types) may be used in an amount of 0.01 mol or more and 3.0 mol or less in terms of V.

### [2] Form and Properties of Dielectric Ceramic Composition

The form of the dielectric ceramic composition in the embodiment is not limited to any particular example. The dielectric ceramic composition may have the form of platelet, sphere, pellet, and the like, or a composite form in which the forms are combined.

The dielectric ceramic composition in the embodiment may have excellent capacitance-temperature properties. Specifically, the composition may exhibit a low capacitance-temperature change rate in the range of room temperature to 200° C. or more. The capacitance-temperature change rate AC may be defined by the equation as below:

Capacitance-temperature change rate ΔC=[{(capacitance at target temperature)−(capacitance at 25° C.)}/(capacitance at 25° C.)]×100 (%) [Equation 1]

The capacitance-temperature change rate ΔC at 25° C. or more and 200° C. or less of the dielectric ceramic composition in the embodiment may be preferably −50% or more and within +20%, or more preferably, within ±20%. Meanwhile, in the above equation, the capacitance at each temperature may be measured by the method described in the embodiment.

### [3] Method of Manufacturing Dielectric Ceramic Composition

The dielectric ceramic composition in the embodiment may be manufactured, for example, in processes (a1) to (a3) as below. However, the method of manufacturing the dielectric ceramic composition in the embodiment is not limited thereto.
(a1) A first calcining process of forming first calcined powder by calcining BaCO₃, TiO₂ and RO by a solid phase method.
(a2) A second calcining process of forming a base material of a dielectric ceramic composition by further calcining a mixture of the first calcined powder obtained in the first calcining process of (a1) and WO₃.
(a3) Main-firing process of obtaining a dielectric ceramic composition by main-firing the base material obtained in the second calcining process of (a2) above and additives.

In this case, the base material may be represented as Ba(Ti₍₁₋₂ₓ₎RₓWₓ)O₃ and may be a barium titanate compound having a perovskite structure. In the base material, a portion of Ti site of barium titanate may be substituted with R and W. R may be Mn and/or Mg. R may include both Mn and Mg. x may satisfy 0.06≤x≤0.10.

Hereinafter, each process will be described in greater detail.

### (a1) First Calcining Process

In this process, first calcined powder may be formed by calcining BaCO₃, TiO₂ and RO. As raw materials, BaCO₃, TiO₂ and RO may be weighed and mixed, and the mixture thereof may be heat-treated (calcined) by a solid phase method. The amounts of BaCO₃, TiO₂ and RO may be adjusted such that “x” of the base material obtained in the second calcining process of (a2) may fall within the range of 0.06≤x≤0.10. When using a solid phase method, for example, BaCO₃, TiO₂ and RO may be wet-mixed in a solvent. The mixture may be dried, may be coarsely pulverized and calcined to form first calcined powder.

The solvent used for the wet-mixing is not limited to any particular example. For example, water, an alcohol solvent, a glycol solvent, a ketone solvent, an ester solvent, an ether solvent, an aromatic solvent, or a combination of two or more thereof may be used. As an alcohol solvent, ethanol, methanol, benzyl alcohol, methoxyethanol, or the like, may be used. Ethylene glycol, diethylene glycol, or the like, may be used as a glycol solvent. As a ketone solvent, acetone, methyl ethyl ketone, methyl isobutyl ketone, cyclohexanone, or the like, may be used. As an ester solvent, butyl acetate, ethyl acetate, carbitol acetate, butyl carbitol acetate, or the like, may be used. As an ether solvent, methyl cellosolve, ethyl cellosolve, butyl ether, tetrahydrofuran, or the like, may be used. As an aromatic solvent, benzene, toluene, xylene, or the like, may be used.

The amount of the solvent used may be preferably 0.5 times or more and 10 times or less of the total mass of BaCO₃, TiO₂ and RO. The amount of solvent used may be more preferably 0.7 times or more and 5 times or less. Within the above range, BaCO₃, TiO₂ and RO may be sufficiently mixed.

In the wet-mixing, a wet ball mill or a stirring mill may be used. When using a wet ball mill, a plurality of zirconia balls having a diameter of 0.1 mm or more and 10 mm or less may be used. The mixing time of the wet-mixing may be, for example, 8 hours or more and 48 hours or less, preferably 10 hours or more and 24 hours or less.

The temperature of calcination may be preferably 600° C. or more and 1200° C. or less, more preferably 700° C. or more and 1150° C. or less, and more preferably 700° C. or more and 1100° C. or less.

The holding time of calcining is not limited to any particular example, but may be preferably 1 hour or more and 5 hours or less, and more preferably 1 hour or more and 3 hours or less. The firing atmosphere is not limited to any particular example, and may be a vacuum, an air atmosphere, or an inert gas atmosphere such as nitrogen or argon.

As other firing conditions, a temperature increase rate may be preferably 50° C./hour or more and 500° C./hour or less, more preferably 70° C./hour or more and 200° C./hour or less.

### (a2) Second Calcining Process

In this process, a base material of a dielectric ceramic composition may be formed by further calcining the mixture of the first calcined powder obtained in the process of (a1) and WO₃. The first calcined powder and WO₃ may be weighed and mixed, and the mixture may be heat-treated (calcined) by a solid phase method. The amount of WO₃ may be adjusted such that “x” of the base material obtained in the second calcining process may fall within the range of 0.06≤x≤0.10. In the case of manufacturing by the solid phase method, for example, the first calcined powder and WO3 may be wet-mixed in a solvent. The mixture may be dried, may be coarsely pulverized and may be calcined to form second calcined powder.

The solvent used for wet-mixing is not limited to any particular example. For example, water, an alcohol solvent, a glycol solvent, a ketone solvent, an ester solvent, an ether solvent, an aromatic solvent, or a combination of two or more thereof may be used. As an alcohol solvent, ethanol, methanol, benzyl alcohol, methoxyethanol, or the like, may be used. As a glycol solvent, ethylene glycol, diethylene glycol, or the like, may be used. As a ketone solvent, acetone, methyl ethyl ketone, methyl isobutyl ketone, cyclohexanone, or the like, may be used. As an ester solvent, butyl acetate, ethyl acetate, carbitol acetate, and butyl carbitol acetate may be used. As an ether solvent, methyl cellosolve, ethyl cellosolve, butyl ether, tetrahydrofuran, or the like, may be used. As an aromatic solvent, benzene, toluene, xylene, or the like, may be used.

The amount of solvent used may be preferably 0.5 times or more and 10 times or less of the total mass of the first calcined powder and WO₃. The amount of solvent used may be more preferably 0.7 times or more and 5 times or less. Within the aforementioned range, the first calcined powder and WO₃ may be sufficiently mixed.

In wet-mixing, a wet ball mill or a stirring mill may be used. In the case of using a wet ball mill, a plurality of zirconia balls having a diameter of 0.1 mm or more and 10 mm or less may be used. The mixing time of wet-mixing may be, for example, 8 hours or more and 48 hours or less, preferably 10 hours or more and 24 hours or less.

The temperature of calcining may be preferably 600° C. or more and 1200° C. or less, more preferably 700° C. or more and 1150° C. or less, and more preferably 700° C. or more and 1100° C. or less. When the firing temperature is within the above range, it may be preferable in that the firing may be performed sufficiently and defects of the obtained base material may decrease.

The holding time of calcining is not limited to any particular example, and may be preferably 1 hour or more and 5 hours or less, and more preferably 1 hour or more and 3 hours or less. The firing atmosphere is not limited to any particular example, and may be in a vacuum, in an air atmosphere, or in an inert gas atmosphere such as nitrogen or argon.

As other firing conditions, the temperature increase rate may be preferably 50° C./hour or more and 500° C./hour or less, more preferably 70° C./hour or more and 200° C./hour or less.

### (a3) Main-Firing Process

In this process, the dielectric ceramic composition may be obtained by main-firing the base material obtained in the process of (a2) and additives. The formed object may be main-fired by forming the mixture obtained by mixing the base material obtained in the process of (a2) and additives.

First, the base material and additives obtained in the process of (a2) may be wet-mixed in a solvent. A slurry may be prepared by wet-mixing the components of the dielectric ceramic composition in the embodiment in a solvent. Meanwhile, the additive may include a subcomponent of dielectric ceramic composition, a binder, a plasticizer, a dispersant, and the like. Also, additives may include a lubricant, an antistatic agent, and the like.

The solvent used for wet-mixing is not limited to any particular example. For example, water, an alcohol solvent, a glycol solvent, a ketone solvent, an ester solvent, an ether solvent, an aromatic solvent, or a combination of two or more thereof may be used. As an alcohol solvent, ethanol, methanol, benzyl alcohol, methoxyethanol, or the like, may be used. As a glycol solvent, ethylene glycol, diethylene glycol, or the like, may be used. As a ketone solvent, acetone, methyl ethyl ketone, methyl isobutyl ketone, cyclohexanone, or the like, may be used. As the ester solvent, butyl acetate, ethyl acetate, carbitol acetate, butyl carbitol acetate, or the like, may be used. As an ether solvent, methyl cellosolve, ethyl cellosolve, butyl ether, tetrahydrofuran, or the like, may be used. As an aromatic solvent, benzene, toluene, xylene, or the like, may be used.

Among the above solvents, an alcohol solvent and aromatic solvent may be preferable. By these solvents, solubility and dispersibility of various additives included in slurry may be good. The alcohol solvent may be preferably a low boiling point solvent such as methanol or ethanol. Also, the aromatic solvent may be preferably a low boiling point solvent such as toluene. The solvents may be used alone or a combination of two or more types of solvents may be used in an arbitrary combination and ratio. When mixing two or more types of solvents, preferably, the alcohol solvent and aromatic solvent may be mixed.

The amount of the solvent may be preferably 0.5 times or more and 10 times or less of the total mass of the base material and the additives. The amount of solvent used may be more preferably 0.7 times or more and 5 times or less. Within the above range, the base material, additives, or the like, may be sufficiently mixed. Furthermore, the operation of removing the solvent thereafter may be carried out conveniently.

A binder included in the slurry is not limited to any particular example. For example, polyvinyl alcohol (PVA), polyvinyl butyral (PVB), acrylic resin, or the like, may be used. Meanwhile, the binder may be used alone or a combination of two or more types of binders may be used.

The amount of the binder used is not limited to any particular example. Preferably, the binder may be 0.01 mass % or more and 20 mass % or less based on the total mass of the base material and additives. More preferably, the binder may be 0.5 mass % or more and 15 mass % or less. By determining the range as above, density of a formed object may improve.

A plasticizer which may be included in the slurry is not limited to any particular example. For example, a phthalic acid plasticizer such as dioctyl phthalate (DOP), benzylbutyl phthalate, dibutyl phthalate, dihexyl phthalate, di(2-ethylhexyl) phthalate (DEHP), di(2-ethylbutyl phthalate), an adipic acid plasticizer such as dihexyl dipicte and di(2-ethylhexyl) adipate (DOA), a glycol plasticizer such as ethylene glycol, diethylene glycol, and triethylene glycol, and a glycol ester plasticizer such as triethylene glycol dibutylate, triethylene glycol di(2-ethyl butylate), and triethylene glycol di(2-ethylhexanoate), or the like, may be used. Among the plasticizers, a phthalic acid plasticizer, such as dioctyl phthalate, dibutyl phthalate, and di(2-ethylhexyl) phthalate, may be used preferably. When the phthalic acid plasticizer is used, flexibility of a green sheet prepared from the slurry may be improved. The above plasticizers may be used alone or a combination of two or more types of plasticizers may be used.

The amount of plasticizer used is not limited to any particular example. Preferably, the plasticizer may be 5 mass % or more and 50 mass % or less based on the total mass of the binder to be added. More preferably, the plasticizer is 10 mass % or more and 50 mass % or less. Especially preferably, the plasticizer may be 15 mass % or more and 30 mass % or less. By determining the amount to be in the above range, the effect of a plasticizer may be sufficiently obtained.

A dispersant which may be included in the slurry is not limited to any particular example. For example, a phosphoric acid ester dispersant, a polycarboxylic acid dispersant, or the like, may be used. Among the dispersants, a phosphoric acid ester dispersant is preferable. Meanwhile, the dispersants may be used alone or a combination of two or more types of dispersants may be used.

The amount of dispersant used is not limited to any particular example. Preferably, the dispersant may be 0.1 mass % or more and 5 mass % or less based on the total mass of the base material and additives. More preferably, the dispersant may be 0.3 mass % or more and 3 mass % or less. More preferably, the dispersant may be 0.5 mass % or more and 1.5 mass % or less. By determining the dispersant to be in the above range, the effect of a dispersant may be sufficiently obtained.

As a method of wet-mixing, a wet ball mill, a stirring mill, or a bead mill may be used. The wet ball mill may be a large number of zirconia balls having a diameter of 0.1 mm or more and 10 mm or less. The mixing time of wet-mixing may be, for example, 8 hours or more and 48 hours or less. Preferably, the mixing time may be 10 hours or more and 24 hours or less.

The slurry may be formed to have a predetermined size and shape, and a formed body may be obtained. The formed body may be formed into a sheet. For example, the slurry may be formed into a sheet shape by a doctor blade method or a die coater method. Thereafter, the obtained sheets may be laminated and may go through a hot-press forming process. If desired, the formed body may be cut into a desired shape such as a chip shape. Accordingly, a green sheet may be formed.

The thickness of the green sheet (thickness after drying) is not limited to any particular example. Preferably, the thickness of the green sheet may be 30 μm or less. More preferably, the thickness of the green sheet may be 20 μm or less. The lower limit of the thickness of the green sheet (thickness after drying) is not limited to any particular example. The thickness of the green sheet may be substantially 0.5 μm or greater.

The green sheets may be laminated until a desired thickness is obtained, and may be hot-pressed thereafter. Also, the conditions of hot-pressing are not limited to any particular example. Preferably, the temperature of hot-pressing may be 50° C. or more and 150° C. or less. Preferably, the pressure of hot-pressing may be 10 MPa or more and 200 MPa or less. Preferably, the pressing time may be one minute or more and thirty minutes or less. As a method of hot-pressing, a warm isostatic press (WIP) may be used.

Thereafter, the laminated green sheets may be cut. Accordingly, a green chip having a desired chip shape may be manufactured.

The binder component included in the obtained green sheet (or green chip) may be preferably removed by thermal decomposition (degreasing treatment). The conditions for the degreasing treatment may depend on the type of binder used, but are not limited to any particular example. Preferably, the degreasing conditions may be 180° C. or more and 450° C. or less. Also, the degreasing treatment time is not limited to any particular example. Preferably, the degreasing treatment time may be 0.5 hour or more and 24 hours or less. The degreasing treatment may be performed in air or in an inert gas such as nitrogen or argon. In terms of simplicity of process management, the degreasing treatment may be preferably performed in the air.

The main-firing may be performed by the method as below as an example. The main-firing may be performed on the formed object after the binder removal process. The temperature of the main-firing may be less than 1400° C. The lower limit of the main-firing temperature is not limited to any particular example. Preferably, the lower limit may be 1000° C. or higher. More preferably, the lower limit may be 1150° C. or higher. The temperature range of the main-firing may be more preferably 1200° C. or more and 1400° C. or less. Preferably, the range of the temperature may be 1230° C. or more and 1360° C. or less. The firing holding time is not limited to any particular example, and may be 1 hour or more and 5 hours or less. Preferably, the firing holding time may be 1 hour or more and 3 hours or less. The temperature increase condition may be 50° C./hour or more and 500° C./hour or less. Preferably, the temperature increase condition may be 70° C./hour or more and 200° C./hour or less. The firing atmosphere is not limited to any particular example and may be under an inert gas atmosphere or under a reducing atmosphere. The reducing atmosphere may be a mixture of hydrogen and/or water vapor in an inert gas.

The dielectric ceramic composition in the embodiment may be manufactured in processes (b1) to (b3) as below:
(b1) A first calcining process of forming first calcined powder by calcining TiO₂, RO and WO₃ by a solid phase method.
(b2) A second calcining process of forming a base material of the dielectric ceramic composition by further calcining a mixture of the first calcined body obtained in the process of (b1) and BaCO₃.
(b3) Main-firing process of obtaining a dielectric ceramic composition by main-firing the base material obtained in the process of (b2) above and additives.

In this case, the base material may be represented as Ba(Ti₍₁₋₂ₓ₎RₓWₓ)O₃ and may be a barium titanate compound having a perovskite structure. In the base material, portion of Ti site of barium titanate may be substituted with R and W. R may be Mn and/or Mg. R may include both Mn and Mg. x may satisfy 0.06≤x≤0.10.

Hereinafter, each process will be described in greater detail.

### (b1) First Calcining Process

In this process, first calcined powder may be formed by calcining TiO₂, RO and WO₃. As raw materials, TiO₂, RO and WO₃ may be weighed and mixed, and the mixture may be heat-treated (calcined) by a solid phase method. The amounts of TiO₂, RO and WO₃ may be adjusted such that “x” of the base material obtained in the second calcining process of (b2) may fall within the range of 0.06≤x≤0.10. In the case of using a solid phase method, for example, TiO₂, RO and WO₃ may be wet-mixed in a solvent. The mixture may be dried, may be coarsely pulverized and may be calcined to form the first calcined powder.

The solvent used for wet-mixing is not limited to any particular example. For example, water, an alcohol solvent, a glycol solvent, a ketone solvent, an ester solvent, an ether solvent, an aromatic solvent, or a combination of two or more thereof may be used. As an alcohol solvent, ethanol, methanol, benzyl alcohol, methoxyethanol, or the like, may be used. As a glycol solvent, ethylene glycol, diethylene glycol, or the like, may be used. As a ketone solvent, acetone, methyl ethyl ketone, methyl isobutyl ketone, cyclohexanone, or the like, may be used. As an ester solvent, butyl acetate, ethyl acetate, carbitol acetate, and butyl carbitol acetate may be used. As an ether solvent, methyl cellosolve, ethyl cellosolve, butyl ether, tetrahydrofuran, or the like, may be used. As an aromatic solvent, benzene, toluene, xylene, or the like, may be used.

The amount of the solvent used may be preferably 0.5 times or more and 10 times or less based on the total mass of TiO₂, RO and WO₃. The amount of solvent used may be more preferably 0.7 times or more and 5 times or less. Within the above range, TiO₂, RO and WO₃ may be sufficiently mixed.

In the wet-mixing, a wet ball mill or a stirring mill may be used. In the case of using a wet ball mill, a plurality of zirconia balls having a diameter of 0.1 mm or more and 10 mm or less may be used. The mixing time of wet-mixing may be, for example, 8 hours or more and 48 hours or less, preferably 10 hours or more and 24 hours or less.

The temperature of calcining may be preferably 600° C. or more and 1200° C. or less, more preferably 700° C. or more and 1150° C. or less, and more preferably 700° C. or more and 1100° C. or less.

The holding time of calcining is not limited to any particular example, and may be preferably 1 hour or more and 5 hours or less, and more preferably 1 hour or more and 3 hours or less. The firing atmosphere is not limited to any particular example, and may be in a vacuum, in an air atmosphere, or in an inert gas atmosphere such as nitrogen or argon.

As other firing conditions, the temperature increase rate may be preferably 50° C./hour or more and 500° C./hour or less, more preferably 70° C./hour or more and 200° C./hour or less.

### (b2) Second Calcining Process

In this process, a base material of a dielectric ceramic composition may be formed by further calcining a mixture of the first calcined powder obtained in the process of (b1) and BaCO₃. The first calcined powder and BaCO₃ may be weighed and mixed, and the mixture may be heat-treated (calcined) by a solid phase method. The amount of BaCO₃ may be adjusted such that “x” of the base material obtained in the second calcining process may fall within the range of 0.06≤x≤0.10. In the case of manufacturing by the solid phase method, for example, the first calcined powder and BaCO₃ may be wet-mixed in a solvent. The mixture may be dried, may be coarsely pulverized and calcined to form second calcined powder.

The solvent used for wet-mixing is not limited to any particular example. For example, water, an alcohol solvent, a glycol solvent, a ketone solvent, an ester solvent, an ether solvent, an aromatic solvent, or a combination of two or more thereof may be used. As an alcohol solvent, ethanol, methanol, benzyl alcohol, methoxyethanol, or the like, may be used. As a glycol solvent, ethylene glycol, diethylene glycol, or the like, may be used. As a ketone solvent, acetone, methyl ethyl ketone, methyl isobutyl ketone, cyclohexanone, or the like, may be used. As an ester solvent, butyl acetate, ethyl acetate, carbitol acetate, and butyl carbitol acetate may be used. As an ether type solvent, methyl cellosolve, ethyl cellosolve, butyl ether, tetrahydrofuran, or the like, may be used. As an aromatic solvent, benzene, toluene, xylene, or the like, may be used.

The amount of the solvent used may be preferably 0.5 times or more and 10 times or less based on the total mass of the first calcined powder and BaCO₃. The amount of solvent used may be more preferably 0.7 times or more and 5 times or less. Within the above range, the first calcined powder and BaCO₃ may be sufficiently mixed.

In the wet-mixing, a wet ball mill or a stirring mill may be used. In the case of using a wet ball mill, a plurality of zirconia balls having a diameter of 0.1 mm or more and 10 mm or less may be used. The mixing time of wet-mixing may be, for example, 8 hours or more and 48 hours or less, preferably 10 hours or more and 24 hours or less.

The temperature of calcining may be preferably 600° C. or more and 1200° C. or less, more preferably 700° C. or more and 1150° C. or less, and more preferably 700° C. or more and 1100° C. or less. When the firing temperature is within the above range, it may be preferable in that firing may be performed sufficiently and defects of the obtained base material may decrease.

The holding time of calcining is not limited to any particular example, and may be preferably 1 hour or more and 5 hours or less, and more preferably 1 hour or more and 3 hours or less. The firing atmosphere is not limited to any particular example, and may be in a vacuum, in an air atmosphere, or in an inert gas atmosphere such as nitrogen or argon.

As other firing conditions, the temperature increase rate may be preferably 50° C./hour or more and 500° C./hour or less, more preferably 70° C./hour or more and 200° C./hour or less.

### (b3) Main-Firing Process

In this process, the dielectric ceramic composition may be obtained by main-firing the base material obtained in the process of (b2) and additives. The formed object may be main-fired by forming the mixture obtained by mixing the base material obtained in the process of (b2) and additives.

First, the base material obtained in the process of (b2) and additives may be wet-mixed in a solvent. Slurry may be prepared by wet-mixing the components of the dielectric ceramic composition in the embodiment in a solvent. Meanwhile, the additive may include a subcomponent of dielectric ceramic composition, a binder, a plasticizer, a dispersant, and the like. Also, additives may include a lubricant, an antistatic agent, and the like.

The solvent used for wet-mixing is not limited to any particular example. For example, water, an alcohol solvent, a glycol solvent, a ketone solvent, an ester solvent, an ether solvent, an aromatic solvent, or a combination of two or more thereof may be used. As an alcohol solvent, ethanol, methanol, benzyl alcohol, methoxyethanol, or the like, may be used. As a glycol solvent, ethylene glycol, diethylene glycol, or the like, may be used. As a ketone solvent, acetone, methyl ethyl ketone, methyl isobutyl ketone, cyclohexanone, or the like, may be used. As an ester solvent, butyl acetate, ethyl acetate, carbitol acetate, and butyl carbitol acetate may be used. As an ether type solvent, methyl cellosolve, ethyl cellosolve, butyl ether, tetrahydrofuran, or the like, may be used. As an aromatic solvent, benzene, toluene, xylene, or the like, may be used.

Among the solvents, preferably, alcohol solvents and aromatic solvents may be used. By these solvents, solubility and dispersibility of various additives included in slurry may be good. The alcohol solvent may be preferably a solvent having a low boiling point such as methanol or ethanol. Also, the aromatic solvent may be preferably a solvent having a low boiling point such as toluene. The solvent may be used alone or a combination of two or more types of solvents may be used in any combination and ratio. When mixing two or more types of solvents, preferably, the alcohol solvent and aromatic solvent may be mixed.

The amount of solvent used may be preferably 0.5 times or more and 10 times or less based on the total mass of the base material and additives. The amount of solvent used may be more preferably 0.7 times or more and 5 times or less. Within the above range, the base material and additives may be sufficiently mixed. Furthermore, the operation of removing the solvent afterwards may be carried out conveniently.

A binder which may be included in the slurry is not limited to any particular example. For example, polyvinyl alcohol (PVA), polyvinyl butyral (PVB), acrylic resin, or the like, may be used. Meanwhile, the binder may be used alone or a combination of two or more types of binders may be used.

The amount of the binder used is not limited to any particular example. Preferably, the binder may be 0.01 mass % or more and 20 mass % or less based on the total mass of the base material and additives. More preferably, the binder may be 0.5 mass % or more and 15 mass % or less. By determining the range as above, density of a formed object may improve.

A plasticizer which may be included in the slurry is not limited to any particular example. For example, a phthalic acid plasticizer such as dioctyl phthalate (DOP), benzylbutyl phthalate, dibutyl phthalate, dihexyl phthalate, di(2-ethylhexyl) phthalate (DEHP), di(2-ethylbutyl phthalate), an adipic acid plasticizer such as dihexyl dipicte and di(2-ethylhexyl) adipate (DOA), a glycol plasticizer such as ethylene glycol, diethylene glycol, and triethylene glycol, and a glycol ester plasticizer such as triethylene glycol dibutylate, triethylene glycol di(2-ethyl butylate), and triethylene glycol di(2-ethylhexanoate), or the like, may be used. Among the plasticizers, a phthalic acid plasticizer, such as dioctyl phthalate, dibutyl phthalate, and di(2-ethylhexyl) phthalate, may be used preferably. When the phthalic acid plasticizer is used, flexibility of a green sheet prepared from the slurry may be improved. The above plasticizers may be used alone or a combination of two or more types of plasticizers may be used.

The usage amount of the plasticizer is not limited to any particular example. Preferably, the plasticizer may be 5 mass % or more and 50 mass % or less based on the total mass of the binder to be added. More preferably, the plasticizer may be 10 mass % or more and 50 mass % or less. Preferably, the plasticizer may be 15 mass % or more and 30 mass % or less. By determining the range as above, the effect of a plasticizer may be sufficiently obtained.

The dispersant which may be included in the slurry is not limited to any particular example. For example, phosphoric acid ester-type dispersant, polycarboxylic acid dispersant, or the like, may be used. Among the dispersants, a phosphoric acid ester dispersant may be preferable. Meanwhile, the dispersants may be used alone or a combination of two or more types of dispersants may be used.

The amount of dispersant used is not limited to any particular example. Preferably, the dispersant may be 0.1 mass % or more and 5 mass % or less based on the total mass of the base material and additives. More preferably, the dispersant may be 0.3 mass % or more and 3 mass % or less. More preferably, the dispersant may be 0.5 mass % or more and 1.5 mass % or less. By determining the range as above, the effect of a dispersant may be sufficiently obtained.

As a method of wet-mixing, a wet ball mill, a stirring mill, or a bead mill may be used. The wet ball mill may be a large number of zirconia balls having a diameter of 0.1 mm or more and 10 mm or less. The mixing time of wet-mixing may be, for example, 8 hours or more and 48 hours or less. Preferably, the mixing time may be 10 hours or more and 24 hours or less.

Thereafter, slurry may be formed to a predetermined size and shape, and a formed object may be obtained. The formed object may be formed into a sheet. For example, the slurry may be formed into a sheet shape by a doctor blade method or a die coater method. Thereafter, the obtained sheets may be laminated and hot-press formed. If desired, the formed object may be cut into a desired shape such as a chip shape. Accordingly, a so-called green sheet may be formed.

The thickness of the green sheet (thickness after drying) is not limited to any particular example. Preferably, the thickness of the green sheet may be 30 μm or less. More preferably, the thickness of the green sheet may be 20 μm or less. The lower limit of the thickness of the green sheet (thickness after drying) is not limited to any particular example. The thickness of the green sheet may be substantially 0.5 μm or greater.

The green sheets may be laminated until the green sheets have a desired thickness, and may be hot-pressed thereafter. Also, the conditions of hot-pressing are not limited to any particular example. Preferably, the temperature of hot-pressing may be 50° C. or more and 150° C. or less. Preferably, the pressure of hot-pressing may be 10 MPa or more and 200 MPa or less. Preferably, the pressing time may be 1 minute or more and 30 minutes or less. As a method of hot-pressing, a warm isostatic pressing method (WIP) may be used.

Thereafter, the laminated green sheets may be cut. Accordingly, a green chip having a desired chip shape may be manufactured.

A binder component included in the obtained green sheet (or green chip) may be preferably removed by thermal decomposition (degreasing treatment). Conditions for the degreasing treatment may depend on the type of binder used, but are not limited to any particular example. Preferably, degreasing conditions may be performed at 180° C. or more and 450° C. or less. Also, the degreasing treatment time is not limited to any particular example. Preferably, the degreasing treatment time may be 0.5 hour or more and 24 hours or less. The degreasing treatment may be performed in air or in an inert gas such as nitrogen or argon. In terms of simplicity of process management, the degreasing treatment may be preferably performed in the air.

The main-firing may be performed by the method as below. Main-firing may be performed on the formed object after the binder removal process. The temperature of the main-firing may be less than 1400° C. The lower limit of the main-firing temperature is not limited to any particular example. Preferably, the lower limit may be 1000° C. or higher. More preferably, the lower limit may be 1150° C. or higher. The temperature range of the main-firing may be more preferably 1200° C. or more and 1400° C. or less. Preferably, the range of the temperature may be 1230° C. or more and 1360° C. or less. The firing holding time is not limited to any particular example, and may be 1 hour or more and 5 hours or less. Preferably, the firing holding time may be 1 hour or more and 3 hours or less. The temperature increase condition may be 50° C./hour or more and 500° C./hour or less. Preferably, the temperature increase condition may be 70° C./hour or more and 200° C./hour or less. The firing atmosphere is not limited to any particular example and may be under an inert gas atmosphere or under a reducing atmosphere. The reducing atmosphere may be a mixture of hydrogen and/or water vapor in an inert gas.

### [4] Application of Dielectric Ceramic Composition

The dielectric ceramic composition in the embodiment may be used for various electronic components. In particular, the dielectric ceramic composition may be used appropriately for electronic components requiring reliability at high temperatures (e.g., over 200° C.). An example of an electronic component may include a capacitor including a dielectric ceramic composition as a dielectric. Another example of an electronic component may include a multilayer ceramic capacitor (MLCC) including a dielectric ceramic composition as a dielectric.

The electronic component may be used, for example, on a power module substrate of an electric vehicle or in the vicinity of the power module substrate, and may require high performance and reliability. For example, the electronic component may be used in power modules including an SiC semiconductor. An MLCC including a dielectric ceramic composition may be manufactured, for example, by the method as below.

First, conductive paste for internal electrodes may be printed on the green sheet obtained in the process of (a3) or (b3). The method of printing may be, for example, screen-printing. Also, as the conductive paste for the internal electrode, Cu, Ni, Pt, Pd, Ag, or the like may be used. A laminate body may be formed by stacking a plurality of green sheets on which conductive paste for internal electrodes is printed.

Thereafter, the laminate body may be interposed between the green sheets on which the conductive paste for internal electrodes is not printed. The laminate body may be compressed. The laminate body may be cut out to form a green chip if desired. The condenser chip body may be obtained by de-binder processing and main-firing of the green chip. Firing conditions may be the same as those of the (a3) process and (b3) process described above. When firing under a reducing atmosphere, the obtained capacitor chip body may be further annealed. Accordingly, reoxidation of the dielectric layer may be possible.

Thereafter, each end surface of the internal electrode exposed from the end face of the capacitor chip body may be connected to an external electrode. For example, the external electrode may be formed by applying conductive paste for external electrodes to the end surfaces. As the conductive paste for external electrodes, materials for conductive paste for internal electrodes may be used. Alternatively, as copper paste, alloys such as Cu, Ag, Ag-10Pd, Ag-coated Cu, and/or carbon materials such as graphite may be used. Also, if desired, a coating layer may be formed on the capacitor chip body by plating.

As an example of an electronic component, a multilayer ceramic capacitor may be used. However, the electronic component according to the embodiment is not limited thereto. For example, various other components such as a high-frequency module, an electronic component for thermistor, or a composite component thereof may be used.

### [5] Embodiment

Embodiments and comparative examples will be described using tables. However, the technical scope of the present disclosure is not limited to the embodiments as below.

### Raw Material

In the embodiments and comparative examples, the materials as below were used as raw materials.
BaCO₃: Rare Metallic Co., Ltd. Ba-40-26-0060
TiO₂: Mitsuwa Chemical Co., Ltd. titanium oxide IV 3N
MgO: Rare Metallic Co., Ltd. MG-76-20-0130
Mn₃O₄: High Purity Chemical Research Institute MNO03PB
WO₃: High Purity Chemical Research Institute WWO03PB

Table 1 lists the compositions of the dielectric ceramic composition in the embodiment and the comparative example.

TABLE 1

| | R | x | Calcination |
|---|---|---|---|
| Embodiment A1 | Mg | 0.06 | Step 2 |
| Embodiment A2 | Mg | 0.10 | Step 2 |
| Embodiment A3 | Mn | 0.06 | Step 2 |
| Embodiment A4 | Mn | 0.10 | Step 2 |
| Embodiment B1 | Mg | 0.06 | Step 2 |
| Embodiment B2 | Mg | 0.10 | Step 2 |
| Comparative | Mg | 0.10 | Step 1 |
| example 1 | | | |
| Comparative | Mn | 0.10 | Step 1 |
| example 2 | | | |
| Comparative | Mn | 0.02 | Step 2 |
| example A5 | | | |
| Comparative | Mn | 0.04 | Step 2 |
| example A6 | | | |
| Comparative | Mg | 0.02 | Step 2 |
| example B3 | | | |
| Comparative | Mg | 0.04 | Step 2 |
| example B4 | | | |

x in Table 1 corresponds to x in the base material Ba(Ti₍₁₋₂ₓ₎RₓWₓ)O₃. “Calcination” in Table 1 represents the number of calcining processes in the process of obtaining the base material of the dielectric ceramic composition. Step 1 may indicate that the calcining process is performed once, and step 2 may indicate that the calcining process is performed twice.

### Embodiment A1

BaCO₃, TiO₂ and MgO were weighed using an electronic balance such that x=0.06. Pure water was added to the weighed material such that the solid content concentration was 33 wt %. Thereafter, wet-mixing was performed with a rotary ball mill for 16 hours. For the rotary ball mill, a ZrO₂ ball of φ3 mm was used. The slurry was obtained and pat dried in the air at 100° C. The obtained dry powder was coarsely pulverized using a pestle and a mortar. The obtained powder was calcined in the air in an alumina crucible (first calcining process). Calcining was performed under conditions of 1000° C.×3 hours (temperature increased at 100° C./hour).

For the obtained first calcined powder, WO₃ was weighed and added with an electronic balance such that x=0.06, and pure water was added such that the solid content concentration was 33 wt %. Thereafter, wet-mixing was performed for 16 hours by a rotary ball mill. For the rotary ball mill, a ZrO₂ ball of φ3 mm as used. The slurry was obtained and bat dried in the air at 100° C. The obtained dry powder was coarsely pulverized using a pestle and mortar. The obtained powder was calcined in the air in an alumina crucible (second calcining process). Calcining was performed under conditions of 1000° C.×3 hours (temperature increased at 100° C./hour). The obtained second calcined powder was coarsely pulverized using a pestle and mortar, and was formed into a pellet shape. The obtained pellet was main-fired under conditions of 1300° C.×5 hours (heating at 100° C./hour).

### Embodiment A2

A dielectric ceramic composition was prepared under the same conditions as those of embodiment A1, other than weighing BaCO₃, TiO₂, MgO and WO₃ to satisfy x=0.10.

### Embodiment A3

A dielectric ceramic composition was prepared under the same conditions as those of embodiment A1, other than weighing BaCO₃, TiO₂, MgO and WO₃ to satisfy x=0.06.

### Embodiment A4

A dielectric ceramic composition was prepared under the same conditions as those of embodiment A1, other than weighing BaCO₃, TiO₂, MgO and WO₃ to satisfy x=0.10.

### Embodiment B1

Using an electronic balance, TiO₂, MgO and WO₃ were weighed such that x=0.06. Pure water was added to the weighed material such that the solid concentration was 33 wt %. Thereafter, wet-mixing was performed for 16 hours by a rotary ball mill. For the rotary ball mill, a ZrO₂ ball of φ3 mm was used. The slurry was obtained and bat dried in the air at 100° C. The obtained dry powder was coarsely pulverized using a pestle and mortar. The obtained powder was calcined in the air in an alumina crucible (first calcining process). Calcining was performed under conditions of 1000° C.×3 hours (temperature increased at 100° C./hour).

Based on the obtained first calcined powder, BaCO₃ was weighed and added with an electronic balance such that x=0.06, and pure water was added such that the solid content concentration was 33 wt %. Thereafter, wet-mixing was performed for 16 hours by a rotary ball mill. For the rotary ball mill, a ZrO₂ ball of φ3 mm was used. The slurry was obtained and bat dried in the air at 100° C. The obtained dry powder was coarsely pulverized using a pestle and mortar. The obtained powder was calcined in the air in an alumina crucible (second calcining process). Calcining was performed under conditions of 1000° C.×3 hours (temperature raised at 100° C./hour). The obtained second calcined powder was coarsely pulverized using a pestle and mortar, and formed into a pellet shape. The obtained pellets were main-fired under conditions of 1300° C.×5 hours (heating at 100° C./hour).

### Embodiment B2

A dielectric ceramic composition was prepared under the same conditions as those of embodiment B1, other than weighing TiO₂, MgO, WO₃ and BaCO₃ to satisfy x=0.10.

### Comparative Example 1

BaCO₃, TiO₂, MgO and WO₃ were weighed using an electronic balance such that x=0.10. Pure water was added to the weighed material such that the solid concentration was 33 wt %. Thereafter, wet-mixing was performed for 16 hours by a rotary ball mill. For the rotary ball mill, a ZrO₂ ball of φ3 mm was used. The slurry was taken out and bat dried in the air at 100° C. The obtained dry powder was coarsely pulverized using a pestle and mortar. The obtained powder was calcined in the air in an alumina crucible. Calcining was performed under conditions of 1000° C.×3 hours (temperature raised at 100° C./hour). The obtained calcined powder was coarsely pulverized using a pestle and mortar, and XRD measurement was performed.

### Comparative Example 2

BaCO₃, TiO₂, MnO and WO₃ were weighed using an electronic balance such that x=0.10. Pure water was added to the weighed material such that the solid concentration was 33 wt %. Thereafter, wet-mixing was performed for 16 hours by a rotary ball mill. For the rotary ball mill, a ZrO₂ ball of φ3 mm was used. The slurry was taken out and bat dried in the air at 100° C. The obtained dry powder was coarsely pulverized using a pestle and mortar. The obtained powder was calcined in the air in an alumina crucible. Calcining was performed under conditions of 1000° C.×3 hours (temperature raised at 100° C./hour). The obtained calcined powder was coarsely pulverized using a pestle and mortar, and XRD measurement was performed.

### Comparative Example A5

A dielectric ceramic composition was prepared under the same conditions as those of embodiment A1, other than weighing BaCO₃, TiO₂, MnO and WO₃ to satisfy x=0.02.

### Embodiment A6

A dielectric ceramic composition was prepared under the same conditions as those of embodiment A1, other than weighing BaCO₃, TiO₂, MnO and WO₃ to satisfy x=0.04.

### Embodiment B3

A dielectric ceramic composition was prepared under the same conditions as embodiment B1, other than weighing TiO₂, MgO, WO₃ and BaCO₃ to satisfy x=0.02.

### Embodiment B4

A dielectric ceramic composition was prepared under the same conditions as embodiment B1, other than weighing TiO₂, MgO, WO₃ and BaCO₃ to satisfy x=0.04.

### Evaluation

The dielectric ceramic composition obtained in the embodiments and comparative examples was evaluated as below.

### (1) STEM/WDS or STEM/EELS Analysis

Among the dielectric grains in each dielectric ceramic composition, the contents of R and W in total of 4 points were analyzed by STEM/WDS or STEM/EELS, and the average value of 4 points was calculated, and the content of RO and WO₃ included in the base material was calculated.

### (2) XRD Analysis

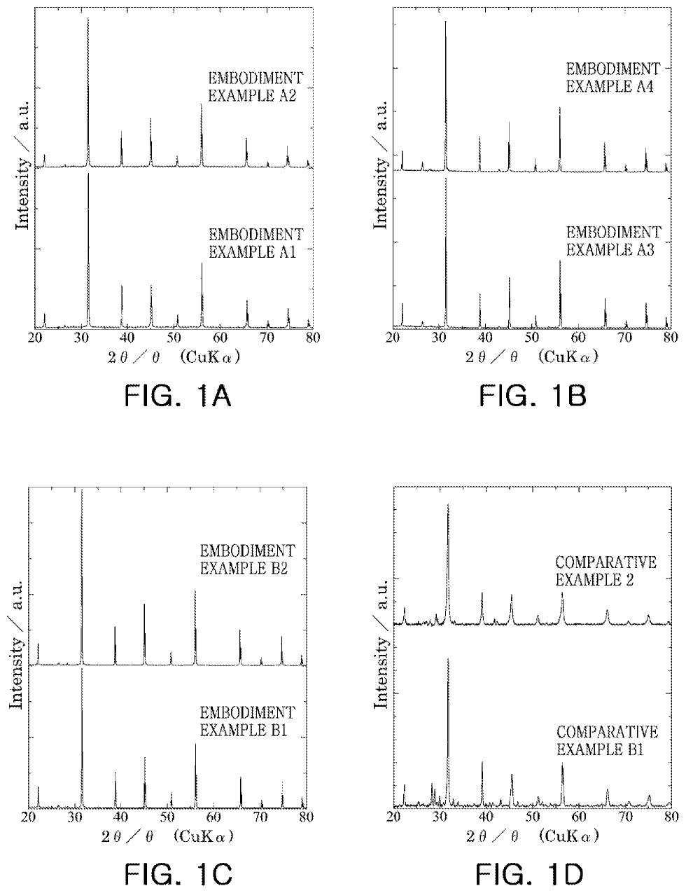

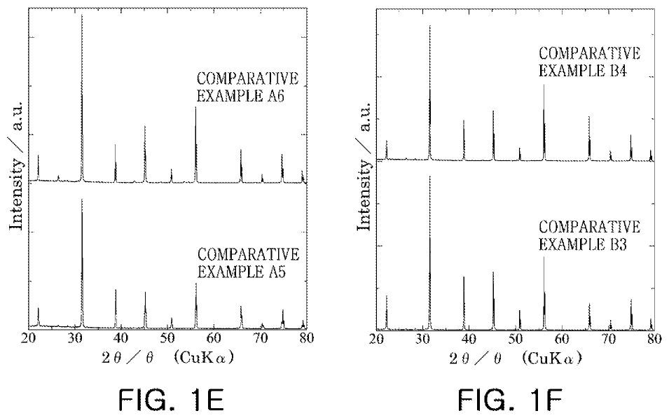

XRD analysis was performed on the dielectric ceramic compositions in the embodiments and comparative examples. Results of graphs of XRD analysis obtained for the embodiments and comparative examples are illustrated in FIGS. 1A, 1B, 1C, 1D, 1E and 1F.

### (3) Capacitance-Temperature Change Rate

The capacitance-temperature change rate of the dielectric ceramic composition obtained by main-firing in the embodiment and the comparative example was evaluated. The evaluation of the capacitance-temperature change rate was measured by measuring the capacitance of the dielectric ceramic composition in the temperature range from 25° C. to 250° C., and calculating the rate of change (unit: %) of the capacitance at each temperature with respect to the capacitance at 25° C. from the measured capacitance value according to the equation as below:

Capacitance-temperature change rate ΔC=[{(capacitance at target temperature)−(capacitance at 25° C.)}/(capacitance at 25° C.)]×100 (%) [Equation 1]

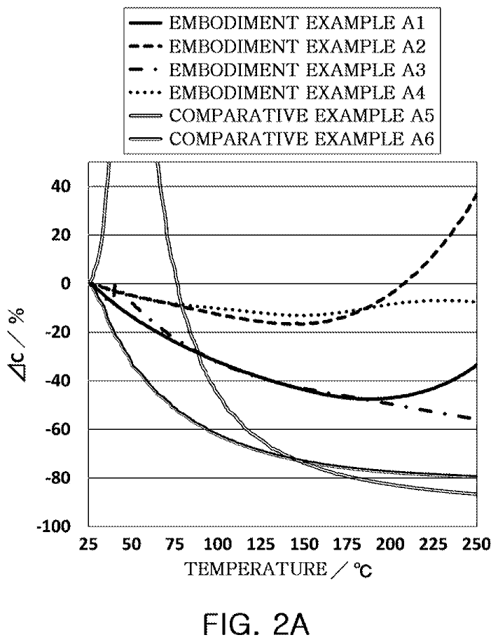

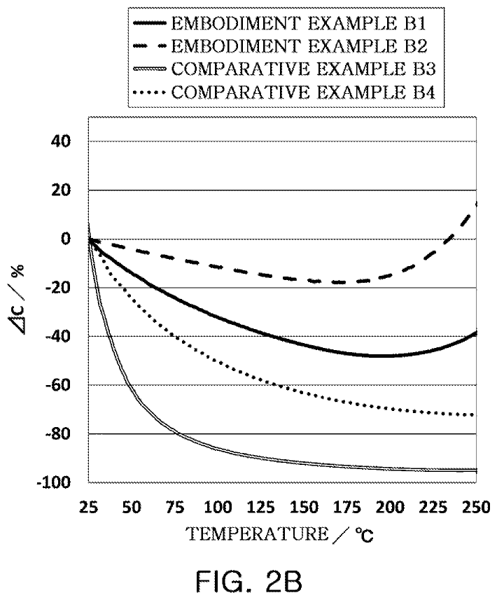

The capacitance was measured by cutting out a sample of 2 mm in width and length from the sintered pellet of the dielectric ceramic composition obtained in the embodiment and the comparative example, and using an electrode formed of a gold sputter. In the measurement of capacitance, an LCR meter was used. The LCR meter used was 6440B manufactured by Wayne Kerr Electronics. Also, the measurement condition was frequency: 1 kHz. Graphs of the capacitance-temperature change rates obtained for the embodiments and comparative examples are illustrated in FIGS. 2A and 2B.

The capacitance-temperature properties were evaluated as below:
o: Capacitance-temperature change rate ΔC from −55° C. to 200° C. was between −50% and +20%.
x: ΔC is out of “−50% or more and within +20%”

### (4) DC Bias Attenuation Rate

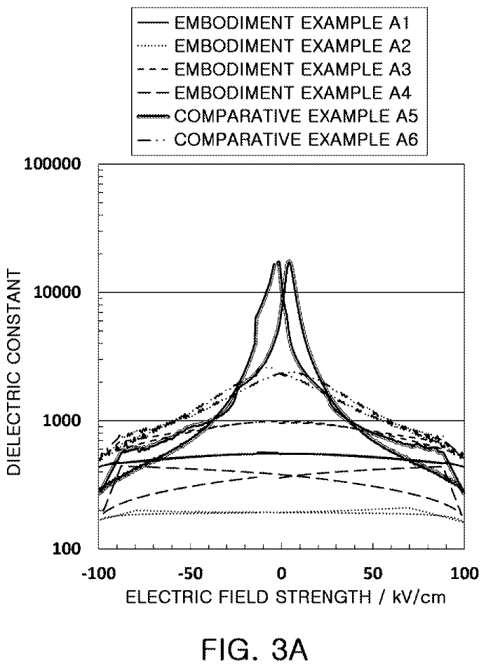

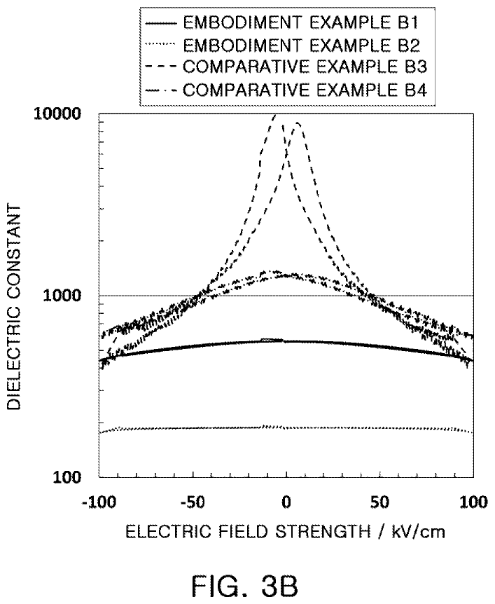

Based on the dielectric ceramic compositions in the embodiments and comparative examples, a change in dielectric constant based on a DC bias was measured. The dielectric constant was measured by measuring a P-E hysteresis loop and converting the measurement into a dielectric constant. For the measurement of the P-E hysteresis loop, Model6252 Rev.C manufactured by Toyo Corporation was used. Also, the measurement condition was frequency: 100 Hz. Graphs of dielectric constant change versus DC bias obtained for the embodiments and comparative examples are illustrated in FIGS. 3A and 3B.

The evaluation of the DC bias attenuation rate was performed as below:
O: DC bias attenuation rate ≤50%
x: DC bias attenuation rate >50%

The DC bias attenuation factor was calculated according to the equation as below, with the zero bias dielectric constant as a reference, and the decrease ratio of the dielectric constant when an electric field strength of ±100 kV/cm was applied.

DC bias attenuation rate (%)=[1-(dielectric constant when ±100 kV/cm applied/zero bias dielectric constant)]×100

Table 2 lists the results of measurement the contents of RO and WO₃ included in the base material of the dielectric ceramic compositions in the embodiments and comparative examples.

TABLE 2

| | (RO + WO₃)/base material (wt %) |
|---|---|
| Embodiment A1 | 5.64 |
| Embodiment A2 | 9.27 |
| Embodiment A3 | 6.57 |
| Embodiment A4 | 10.71 |
| Embodiment B1 | 5.64 |
| Embodiment B2 | 9.27 |
| Comparative example 1 | 9.27 |
| Comparative example 2 | 10.71 |
| Comparative example A5 | 2.24 |
| Comparative example A6 | 4.43 |
| Comparative example B3 | 1.91 |
| Comparative example B4 | 3.80 |

Table 3 lists results of evaluation dielectric ceramic compositions of the embodiments and comparative examples.

TABLE 3

| | Room | | DC-bias attenuation | | |
|---|---|---|---|---|---|
| | temperature | 200° | rate (%) | | |
| | (25° C.) | C.-TC | 100 | −100 | |
| | dielectric | (%) | kV/cm | kV/cm | Evaluation |
| Embodiment | 550 | −47.0 | 20.4 | 16.0 | ◯ |
| A1 | | | | | |
| Embodiment | 192 | −4.6 | 6.8 | 7.3 | ◯ |
| A2 | | | | | |
| Embodiment | 958 | −49.6 | 44.9 | 44.9 | ◯ |
| A3 | | | | | |
| Embodiment | 360 | −8.5 | 48.9 | 48.1 | ◯ |
| A4 | | | | | |
| Embodiment | 555 | −48.0 | 19.6 | 20.9 | ◯ |
| B1 | | | | | |
| Embodiment | 186 | −15.1 | 3.8 | 4.3 | ◯ |
| B2 | | | | | |
| Comparative | 9860 | −82.8 | 97.2 | 96.9 | X |
| example A5 | | | | | |
| Comparative | 2317 | −77.6 | 77.3 | 77.1 | X |
| example A6 | | | | | |
| Comparative | 6321 | −94.4 | 93.1 | 92.7 | X |
| example B3 | | | | | |
| Comparative | 1285 | −69.8 | 55.4 | 52.4 | X |
| example B4 | | | | | |

| | | |
|---|---|---|
| Comparative | No single phase | X |
| example 1 | was obtained | |
| Comparative | No single phase | X |
| example 2 | was obtained | |

Referring to FIGS. 1A to 1F, the dielectric ceramic compositions of embodiments A1 to A4, embodiments B1 and B2, and comparative examples A5, A6, B3 and B4 on which a two-step calcining process was performed, in XRD, no impurity phase peaks appeared, and the result was that the dielectric ceramic composition was a single phase. In the dielectric ceramic compositions of comparative Examples 1 and 2 prepared by the one-step calcining process, it is indicated that peaks of impurity phases were detected, and the dielectric ceramic compositions were not a single-phase.

Referring to Table 2, the content of RO and WO₃ included in the base material in the dielectric ceramic composition was in the range of 5.0 weight % or more and 11.0 weight % or less with respect to the entire base material embodiments A1 to A4, B1 and B2, comparative Example 1 and comparative Example 2. Comparative Examples A5, A6, B3 and B4 were not included in the range of 5.0 weight % or more and 11.0 weight % or less.

From the results of table 3 and FIGS. 2A and 2B, it may be indicated that the dielectric ceramic compositions of embodiments A1 to A4, B1 and B2 had excellent capacitance-temperature properties and satisfied X9M properties, whereas the dielectric ceramic compositions of comparative examples A5, A6, B3 and B4 had lower capacitance-temperature properties and did not satisfy X9M properties (−50%≤ΔC≤+20%).

Accordingly, the multilayer ceramic capacitor to which the dielectric ceramic composition according to the embodiment is applied had excellent temperature properties. That is, the multilayer ceramic capacitor to which the dielectric ceramic composition according to the embodiment is applied may have good temperature properties even at a high temperature exceeding 200° C., and may have excellent high-temperature reliability.

From the results of table 3, FIGS. 3A and 3B, as for the dielectric ceramic compositions of embodiments A1 to A4, B1 and B2, when a DC voltage was applied, even when the DC voltage increased from 0V to ±100 kV/cm, the change in the dielectric constant was low, such that the DC bias attenuation rate satisfied 50% or less. Differently from the embodiment, in the dielectric ceramic compositions of comparative examples A5, A6, B3, and B4, when a DC voltage is applied, the dielectric constant significantly decreased as the DC voltage increased from 0V to ±100 kV/cm.

Accordingly, the dielectric ceramic composition according to the embodiment has excellent DC bias properties. That is, in the multilayer ceramic capacitor to which the dielectric ceramic composition according to the embodiment, since the change in the dielectric constant is small even when a DC voltage is applied, the capacitance may not decrease, such that high capacitance properties may be implemented.

According to the aforementioned embodiments, reliability of multilayer electronic components may be improved.

Also, the X9M TCC properties of the multilayer electronic component may be satisfied.

While the embodiments have been illustrated and described above, it will be configured as apparent to those skilled in the art that modifications and variations could be made without departing from the scope of the present disclosure as defined by the appended claims.

What is claimed is:

1. A dielectric ceramic composition, comprising:
a component including a base material represented by Ba(Ti₍₁₋₂ₓ₎RₓWₓ)O₃,
wherein R is Mn and/or Mg, and
wherein x satisfies 0.06≤x≤0.10.

2. The dielectric ceramic composition of claim 1,
wherein the dielectric ceramic composition is obtained by main-firing at least the base material and additives, and
wherein the base material is calcined powder particles obtained by first calcining BaCO₃, TiO₂ and oxide of R by a solid phase method, mixing with WO₃ and second calcining.

3. The dielectric ceramic composition of claim 1,
wherein the dielectric ceramic composition is obtained by main-firing at least the base material and additives, and
wherein the base material is calcined powder particles obtained by first calcining BaCO₃, TiO₂ oxide of R and WO₃ by a solid phase method, mixing with BaCO₃ and second calcining.

4. The dielectric ceramic composition of claim 1, wherein the base material has a perovskite structure.

5. A multilayer ceramic capacitor, comprising the dielectric ceramic composition in claim 1 as a dielectric.

6. A dielectric ceramic composition, comprising:
a dielectric grain including a base material represented by Ba(Ti₍₁₋₂ₓ₎RₓWₓ)O₃,
wherein R is Mn and/or Mg, and
wherein x satisfies 0.06≤x≤0.10.

7. The dielectric ceramic composition of claim 6,
wherein the dielectric grain does not have a core-shell structure.

8. The dielectric ceramic composition of claim 6,
wherein the dielectric grain has a structure of a homogeneous system.

9. The dielectric ceramic composition of claim 6, wherein a standard deviation of a Ti concentration in the dielectric grain is 1% or less.

10. The dielectric ceramic composition of claim 6, wherein a content of oxide of R and WO₃ included in the base material is 5.0 weight % or more and 11.0 weight % or less based on the entire base material.

11. The dielectric ceramic composition of claim 6, wherein the base material has a perovskite structure.

12. A multilayer ceramic capacitor, comprising the dielectric ceramic composition in claim 6 as a dielectric.

13. A method of manufacturing a dielectric ceramic composition, the method comprising:
a first calcining process of forming first calcined powder particles by calcining BaCO₃, TiO₂ and oxide of R;
a second calcining process of forming a base material of the dielectric ceramic composition by further calcining a mixture of the first calcined powder particles and WO₃; and
a main-firing process of obtaining the dielectric ceramic composition by main-firing the base material and additives,
wherein the base material is represented as Ba(Ti₍₁₋₂ₓ₎RₓWₓ)O₃,
wherein R is Mn and/or Mg, and
wherein x satisfies 0.06≤x≤0.10.

14. A method of manufacturing a dielectric ceramic composition, the method comprising:
a first calcining process of forming first calcined powder particles by calcining TiO₂, oxide of R, and WO₃;
a second calcining process of forming a base material of the dielectric ceramic composition by further calcining a mixture of the first calcined powder particles and BaCO₃; and
a main-firing process of obtaining the dielectric ceramic composition by main-firing the base material and additives,
wherein the base material is represented as Ba(Ti₍₁₋₂ₓ₎RₓWₓ)O₃,
wherein R is Mn and/or Mg, and
wherein x satisfies 0.06≤x≤0.10.
